(19) United States
(12) Patent Application Publication
(10) Pub. No.: US 2025/0033057 A1
(43) Pub. Date: Jan. 30, 2025

(54) RNA OR DNA AMPLIFICATION DEVICE AND METHOD

(71) Applicant: Thierry NAVARRO, Gland (CH)

(72) Inventor: Thierry NAVARRO, Gland (CH)

(21) Appl. No.: 18/033,367

(22) PCT Filed: Oct. 23, 2021
(86) PCT No.: PCT/IB2021/059790

§ 371 Date: Apr. 24, 2023

(30) Foreign Application Priority Data
Oct. 26, 2020 (WO) PCT/IB2020/060026
Dec. 31, 2020 (WO) PCT/IB2020/062596
Jan. 11, 2021 (WO) PCT/IB2020/050175
Feb. 17, 2021 (WO) PCT/IB2021/051660
Feb. 17, 2021 (WO) PCTIB2021/051323

(51) Int. Cl. B01L 7/00

(52) U.S. Cl. CPC B01L 7/52; B01L 2300/042; B01L 2300/087; B01L 2300/123; B01L 2300/18; B01L 2400/043

(57) ABSTRACT

Amplification device comprising a collection compartment connected to a reaction compartment by at least one linking element comprising at least one channel or cavity, for the duplication, in large numbers, of a DNA or RNA sequence of a sample mixed with a solution, part of which is transferred from the collection compartment to the reaction compartment by means of the external actuation of the linking clement

### TECHNICAL FIELD

The present invention relates to a reaction amplification device for duplicating in large number a DNA (deoxyribonucleic acid) or RNA (ribonucleic acid) sequence to detect bacteria, viruses or any other genetic element present in a sample. This device easily lends itself to in vitro analyzes of the PCR (Polymerase Chain Reaction), RT-PCR, qPCR, RT-qPCR, LAMP (Loop-mediated isothermal amplification) or RT-Lamp type used in particular in the context of Covid-19 screening tests.

More particularly, the device of the invention is disposable and configured to receive a saliva sample, a nasal or an oral swab in, at least, one first compartment containing at least one component used to process the sample. The device comprises, at least, a second compartment comprising, at least, a reagent intended for the PCR, LAMP, RT-PCRRT-LAMP type amplification which is designed so as to be able to receive all or part of the contents of the first compartment through a channel having a movable closing and opening mechanism. The device is associated with an apparatus comprising in particular at least one thermoregulated member intended to modify the temperature of the first compartment and at least one second thermoregulated member intended to modify the temperature of the second compartment.

The present invention also relates to a method for implementing the amplification device as well as to a luminescence or fluorescence detector intended to operate together with the device.

### STATE OF THE ART

Many PCR or LAMP amplification systems and methods exist which are based on fluid transfer by pipetting or pumping the sample to be analyzed into tubes to operate different purification steps before being transferred into a tube containing the reagent for the amplification. The preparation time requires many manipulations which slow down sample processing. The final step involves heating the reaction tube into which an aliquot of the purified sample is transferred by pipetting or pumping. During the reaction, it is necessary to reclose (in French: “refermer”) the tube in order to avoid disseminating into air contents which could contaminate the operating personnel and the environment, potentially making the amplification process dangerous, inefficient and polluting.
It is also common for the machines performing these steps to be equipped with filters and UV light in order to reduce the risk of dissemination.
Handling samples is therefore reserved for qualified personnel who must ensure perfect command of the procedure to be applied for each test while guaranteeing safety of the laboratory, operators and result quality.

Although the machines used to perform these PCR and LAMP tests are working, they have several weaknesses that make them complex to implement, expensive and intended for people who must undergo specific training for their use.

There are also means for testing SARS-COV-2 (Covid-19) in particular in a simplified manner such as the “Visby Medical COVID-19 Test” reader which is a disposable system allowing a result to be obtained in 30 minutes based on patent US20160186240A1. This system is also intended for qualified personnel because it also requires manipulating the sample and transferring an aliquot with a pipette into the test compartment. This system is also difficult to recycle and includes many non-disposable components, which poses environmental problems and cannot in any case be used on a large scale.

### DISCLOSURE OF THE INVENTION

A main goal of the present invention is therefore to propose a DNA/RNA amplification device for amplifying at low cost by automatic transfer of the collected sample directly to the reagent intended for the amplification in a safe manner and without external intervention which overcomes the prior art drawbacks, allowing it to be used also by the general public.

A second object of the present invention consists in being able to carry out the PCR or LAMP amplification in a closed compartment obviating any external contamination and health risk.

To this end, the present invention relates more particularly to a DNA/RNA amplification device, of the type mentioned above, characterized in that transferring part of the collected and processed sample towards the amplification reagent is activated by a mobile member.

The present invention also relates to a preferably portable apparatus intended to receive the DNA or RNA amplification device, of the type mentioned above, characterized in that it comprises at least one thermoregulated member.

Thanks to these features, the DNA or RNA amplification device allows detecting a virus present in a sample directly by the user without the intervention of an external person, risk free and at a very low cost. It is thus possible to test a very large part of the population in the context of an epidemic such as that of Covid-19 with very high precision while detecting asymptomatic and symptomatic people. The device in combination with a suitable reader can be produced in large quantities due to its simplified design. The DNA or RNA amplification device can also be integrated into laboratory or mobile test devices that can perform tests in parallel in order to increase the testing capacity. The reader apparatuses associated with this DNA or RNA amplification device are preferably equipped with a network communication system or a wireless communication system so as to be able to communicate the operating parameters, receive commands, transfer data between them and/or with mobile devices such as phones, tablets, PCs or across the Internet to servers. It is thus possible to create an interconnected network of tests, making it possible to process data on a large scale, produce statistical reports in real time, create detailed analysis reports via “Cloud” type services, facilitate the detection of infection outbreaks and communicate to patients instructions to be followed for their treatment or containment.

One of the advantages of the proposed DNA or RNA amplification device is that it allows patients to be able to test themselves on a regular basis, typically every third day, in order to assess how their contamination evolves, and thus avoid unnecessary quarantines. Although certain advantages of the invention are presented above, there are others which are not described but which result from simplifying the diagnostic test process that can be carried out with the disclosed DNA or RNA amplification device.

The present invention further relates to a method for implementing the DNA or RNA amplification device comprising in particular the following steps:
i. opening the device containing a solution,
ii. adding a sample to be analyzed into the collection compartment,
iii. adding an ingredient into the collection compartment,
iv. modifying the temperature the mixture in the collection compartment for a time period,
v. transferring part of the mixture into a reaction compartment, pre-filled with a reagent, by actuating a mobile member,
vi. activating the amplification by modifying the temperature of the reaction compartment to a constant temperature or in a variable manner,
vii. illuminating the reaction compartment and measuring luminescence or fluorescence during amplification,
viii. stopping the amplification,
ix. assessing the result of the amplification and of the DNA or RNA test

### BRIEF DESCRIPTION OF THE DRAWINGS

The present invention will be better understood upon reading the description of the examples, given for illustrative purpose only and in no way limiting, with reference to the appended drawings in which:

FIG. 1 shows a cross-sectional perspective view of the open device in connection with a suction member;

FIG. 2a shows a perspective view of the reaction compartment;

FIG. 2b is a cross-sectional view of FIG. 2a;

FIG. 3a shows a perspective view of the connecting member between the compartments;

FIG. 3b is a cross-sectional view of FIG. 3a ;

FIG. 4a shows a perspective view of the device, fitted with a cap, in closed position as delivered to the user;

FIG. 4b shows a perspective transparent view of the device in open position;

FIG. 4c shows a perspective view of the device provided with a funnel;

FIG. 4d is a perspective transparent view of the reclosed device after having introduced into it the sample to be analyzed;

FIG. 4e is a sectional view of the cap, of the device, in initial position;

FIG. 4f is a sectional view of the cap, of the device, in activated position;

FIG. 5 shows a perspective transparent view of the connecting member for connecting the device compartments in closed position;

FIG. 6a shows a cross-sectional view of the device, wherein the connecting member for connecting the compartments is in closed position, placed in contact with two thermoregulated members;

FIG. 6b shows a cross-sectional view of the device, wherein the connecting member for connecting the compartments is in open position, placed in contact with two thermoregulated members;

FIG. 6c shows a cross-sectional view of the device, wherein the connecting member for connecting the compartments is in reclosed position, placed in contact with two thermoregulated members;

FIG. 7a is a perspective view of a second embodiment of the device;

FIG. 7b is a perspective transparent view of the device second embodiment when the sample to be analyzed is introduced into it;

FIG. 8a is a perspective cross-sectional view of the device second embodiment in connection with a suction member and of which the connecting member is in closed position;

FIG. 8b is a perspective cross-sectional view of the device second embodiment in connection with a suction member and of which the connecting member is in open position;

FIG. 8c is a cross-sectional cross-sectional view of the device second embodiment according to a variant including an air exhaust channel, a mixing and vibration/stirring member;

FIG. 8d is a side view of the device second embodiment according to a variant including a cap containing a solution, an ingredient and an integrated funnel;

FIG. 8e is a view of FIG. 8d according to cross-section A-A comprising the sample to be analyzed;

FIG. 9a shows a cross-sectional view of the device second embodiment, wherein the connecting member for connecting the compartments is in closed position, placed in contact with two thermoregulated members;

FIG. 9b shows a cross-sectional view of the device second embodiment, wherein the connecting member for connecting the compartments is in open position, placed in contact with two thermoregulated members;

FIG. 9c shows a cross-sectional view of the device second embodiment, wherein the connecting member for connecting the compartments is in reclosed position, placed in contact with two thermoregulated members;

FIG. 9d is a perspective cross-sectional view of the device second embodiment, wherein the connecting member for connecting the compartments is in reclosed position, placed in contact with two thermoregulated members;

FIG. 10 shows the amplification process

FIG. 11 is a side view of a variant of the device second embodiment;

FIG. 11a is a view of FIG. 11 according to cross-section A-A, wherein the connecting member is in closed position;

FIG. 11b is a view of FIG. 11 according to cross-section A-A, wherein the connecting member is in open position;

FIG. 11c is a perspective view of a variant of the connecting member;

FIG. 11d is a top view of FIG. 11c;

FIG. 12 is a side view of a variant of the device second embodiment;

FIG. 12a is a view of FIG. 12 according to cross-section A-A, wherein the connecting member is in closed position;

FIG. 12b is a view of FIG. 12 according to cross-section A-A, wherein the connecting member is in open position;

FIG. 12c is a perspective view of a variant of the connecting member;

FIG. 12d is a top view of FIG. 12c;

### EMBODIMENTS OF THE INVENTION

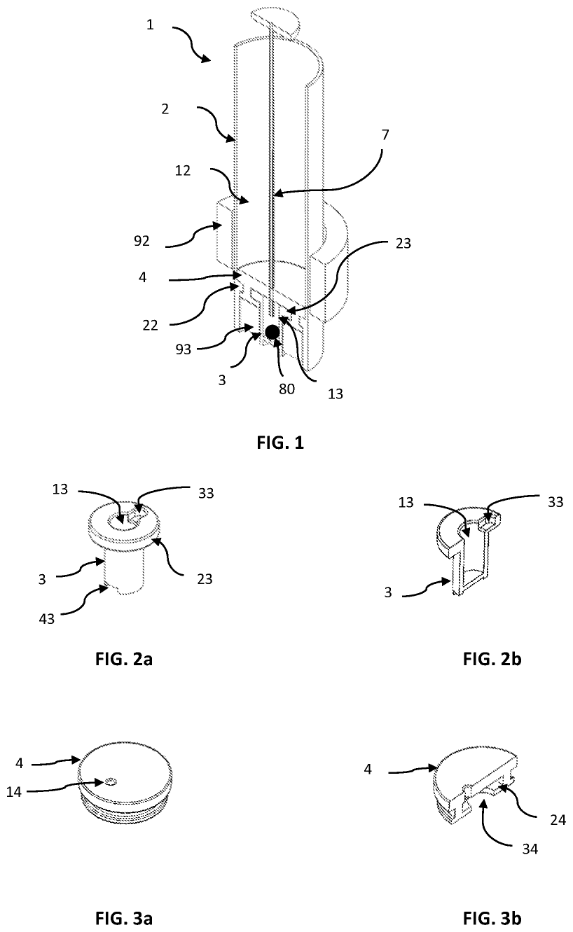

The amplification device (1) according to a first embodiment, as illustrated in particular in FIGS. 1 to 5, comprises a tube (2), preferably made of plastic, a reaction compartment (3), preferably in the form of cylinder or tube, and a connecting member (4), preferably of cylindrical shape.

The cross-section of the tube (2) is preferably designed so as to form a collection compartment (12), the volume of which is preferably less than 30ml, ideally between 1 and 5 ml, and to receive the connecting member (4), preferably made of elastomer.

The amplification device (1) preferably comprises a holding section (22) of the connecting member (4) in such a manner as to ensure its positioning. The support (23) of the reaction compartment (3) is preferably housed in the cavity (24) of the connecting member (4) so as to be able to be firmly held in the connecting member (4).

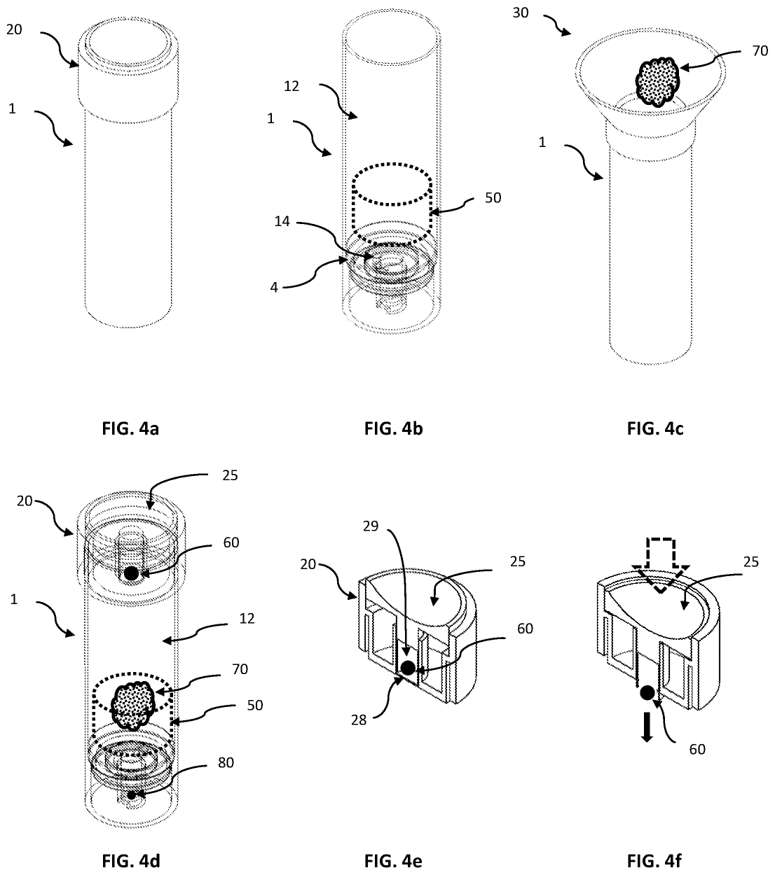

According to FIG. 4a, the amplification device (1) comprises a removable cap (20) ensuring its closure and fluidtightness during transport and use thereof.

According to FIGS. 4b to 4d, the collection compartment (12) is preferably prefilled with a solution (50) provided for processing the sample to be tested. The solution (50) is preferably composed of a mixture used to directly lyse the sample in order to be able to disintegrate the molecular structure of tissues, viruses, cells and bacteria. The sample (70) can be in the form of a nasal or buccal swab, or of any other nature (blood, urine, tissue, etc.) and form (saliva, mucus, phlegm, etc.). The amplification device (1) can be adapted to any type of sample containing DNA or RNA.

The amplification device (1) is designed so as to receive a removable funnel allowing the user to directly spit saliva into the collection compartment (12) which is then in contact with the solution (50).

According to FIGS. 4d to 4f, when the sample (70) is introduced into the collection compartment (12), the cap (20) is placed back onto the amplification device (1) so as to close it. The cap (20) comprises a push button (25) placed in such a manner as to form a cavity (29) intended to contain an ingredient (60), preferably lyophilized as a powder or bead (in French “sous forme lyophilisée en poudre ou bille”), which can be released into the collection compartment (12) by pressing the push button (25) which pierces the membrane (28) at the bottom of the cavity (29).

The ingredient (60) is preferably composed of a proteinase such as proteinase K intended to stabilize the solution mixed with the sample and thus to facilitate its transport, storage and subsequent processing thereof. The ingredient (60) can also be introduced by another means and be of any other nature depending on the type of processing to be carried out. It can also be replaced by a liquid or solid mixture of any types of elements involved in a biological, biochemical or chemical process.

According to FIGS. 2a to 3b, the connecting member (4) comprises a channel (14), preferably on its upper and offset part, in relation to a cavity (24) located, preferably in the center of the connecting member (4) in connection with an opening (34), preferably concentric thereto. The reaction compartment (3) comprises a support (23), a cavity (13) and an indentation (33) preferably placed offset on the upper part of the edge (23) of the reaction compartment (3) in connection with cavity (13).

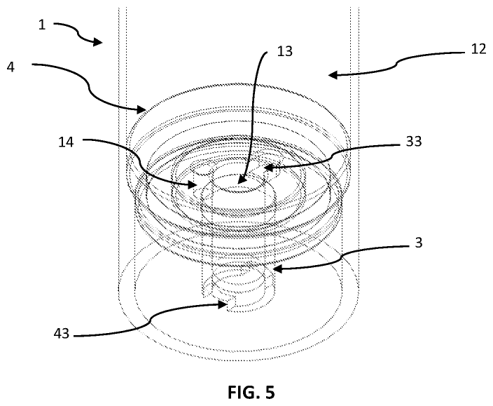

According to FIG. 5, when the support (23) of the reaction compartment (3) is placed in the cavity (24) of the connecting member (4), the indentation (33) is positioned in an offset manner with respect to the channel (14) so as to close the connection between the collection compartment (12) and the reaction compartment (3). This configuration corresponds to the amplification system (1) starting position.

According to FIG. 1, a reagent (80), preferably lyophilized as a powder or bead, is placed in the cavity (13). A removable emptying member (7) pierces the connecting member (4) so as to be able to suck air into the cavity (13) and thus to create a controlled depression. When the emptying member (7) is removed, the connecting member (4), made of elastomer, regains its initial shape and thus maintains the depression in the cavity (13).

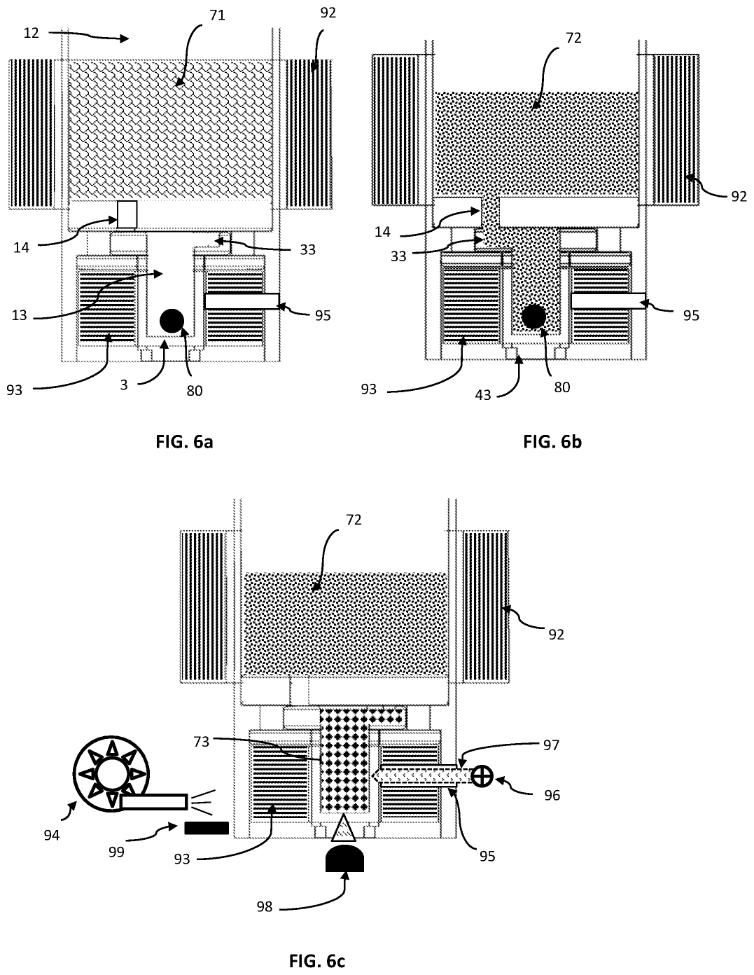

According to FIGS. 6a to 6c, the amplification device (1) is placed in an apparatus (not shown) comprising a first thermoregulated member (92), preferably of annular shape, arranged so as to surround and modify the temperature of the collection compartment (12) and a second thermoregulated member (93), preferably of annular shape, arranged so as to surround and modify the temperature of the cavity (13) of the reaction compartment (3).

The mixture (71) comprising the solution (50), the sample (70) and the ingredient (60) is preferably heated to a temperature above room temperature and preferably in the case of proteinase K to a temperature of 95° C. for 5 minutes by the thermoregulated member (92) so as to deactivate proteinase K. The heating or cooling conditions may vary according to the protocol to be followed and the composition of the mixture (71).

A portion of the heated mixture (72) is then transferred, preferably after a cooling time period, from the collection compartment (12) to the cavity (13) by rotating the reaction compartment (3), via an external mechanism (not shown) engaged with a bearing edge (43) of the reaction compartment (3), so as to put channel (14) in contact with recess (33), which has the effect of sucking in the heated mixture (72) through the initial depression in the cavity (13). The volume of cavity (13) is preferably less than 200 ul and ideally between 25 to 50 ul.

Once the cavity (13) has been filled, the reaction compartment (3) is again turned so as to again isolate cavity (13) from the collection compartment (12). The heated mixture (72) is then combined with the reagent (80) and then heated again via the thermoregulated member (93) so as to carry out the amplification. In the case of an isothermal amplification, the temperature is kept constant whereas, for PCR-type amplification, thermal variation cycles are carried out in combination with the thermoregulated member (93) and a cooling fan (94) and optionally in combination with a cold member (99) preferably in the form of a Peltier module.

During amplification, a light source (96) preferably in the form of a luminescent laser diode illuminates the cavity (13) with a beam (97) through an opening (95) provided in the thermoregulated member (93). A photodiode (98), preferably placed at 90° relative to the beam (97) makes it possible to measure the fluorescence in the cavity (13) and the possible presence of the DNA or RNA sought is thus detected. The system is perfectly adapted to also detect luminescent reactions depending on the type of reagent (80) used.

During the amplification, the cavity (13) preferably remains closed so as to avoid any contamination towards the outside.

### Second Embodiment of the Invention

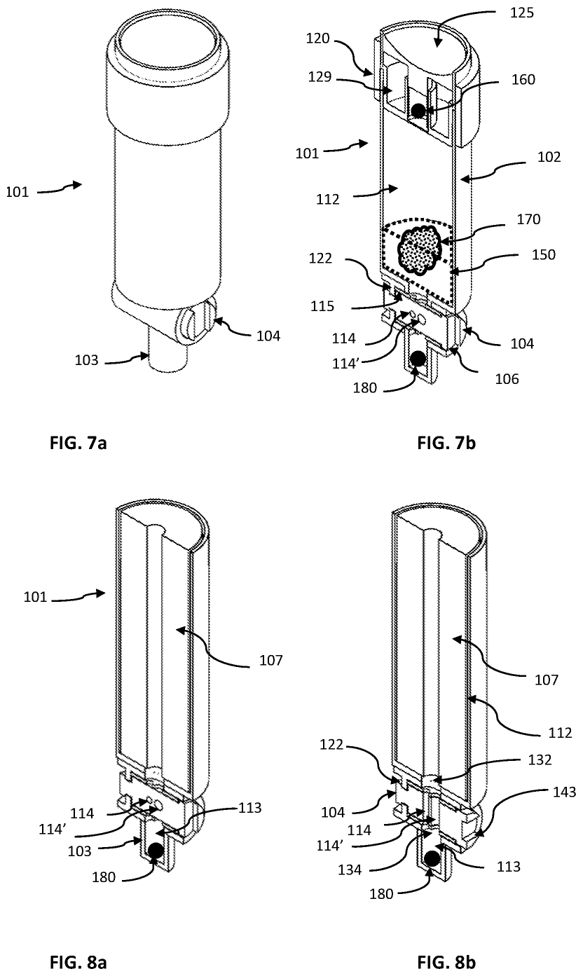

The amplification device (101) according to a second embodiment, as illustrated in particular in FIGS. 7a and 7b, comprises a tube (102), preferably made of plastic, a reaction compartment (103), preferably in the form of cylinder or tube, and a connecting member (104), preferably of cylindrical shape.

The cross-section of the tube (102) is preferably designed so as to form a collection compartment (112), the reaction compartment (103), and to receive the connecting member (104), preferably in connection with a fluidtightness member (115) made of elastomer.

The amplification device (101) preferably comprises a holding section (122) of the connecting member (104) in such a manner as to ensure its positioning. The connecting member (104) is preferably housed in a cavity (106) of the amplification device (101) so as to be able to be firmly held in the amplification device (101).

The amplification device (1) comprises a removable cap (120) ensuring its closure and fluidtightness during transport and use thereof.

The collection compartment (112) is preferably prefilled with a solution (150) provided for processing the sample to be tested. The solution (150) is composed of a mixture used to directly lyse the sample in order to be able to disintegrate the molecular structure of tissues, viruses, cells and bacteria. The sample (170) can be in the form of a nasal or buccal swab, or of any other nature (blood, urine, tissue, etc.) and form (saliva, mucus, phlegm, etc.). The amplification device (101) can be adapted to any type of sample containing DNA or RNA.

The amplification device (101) is designed so as to receive a removable funnel (not shown) allowing the user to directly spit saliva forming the sample (170) into the collection compartment (112) which is then in contact with the solution (150).

When the sample (170) is introduced into the collection compartment (112), the cap (120) is placed back onto the amplification device (101) so as to close it. The cap (120) comprises a push button (125) placed in such a manner as to form a cavity (129) intended to contain an ingredient (160), preferably lyophilized as a powder or bead, which can be released into the collection compartment (112) by pressing the push button (125).

The ingredient (160) is preferably composed of a proteinase such as proteinase K intended to stabilize the solution mixed with the sample and thus to facilitate its transport, storage and subsequent processing thereof. The ingredient (160) can also be introduced by another means and be of any other nature depending on the type of processing to be carried out. It can also be replaced by a liquid or solid mixture of any types of elements involved in a biological, biochemical or chemical process.

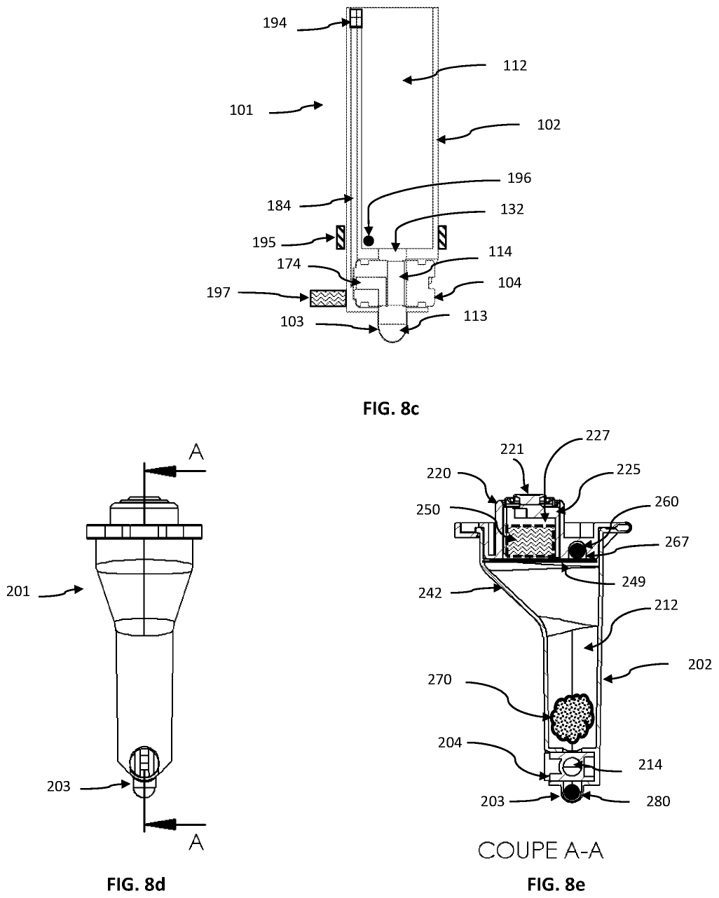

According to FIGS. 8a and 8b, the connecting member (104) comprises a channel (114), and optionally a second channel (114′), in relation to an opening (132) located, preferably at the bottom of the collection compartment (112) and in connection with an opening (134), preferably at the top of the reaction compartment (103). The reaction compartment (103) comprises a cavity (113) in which a reagent (180), preferably lyophilized as a powder or bead, is placed.

According to FIG. 8b, a removable emptying member (107) bears against the bottom of the collection compartment (112) in such a manner as to be able to suck the air into the cavity (113) and thus to create a controlled depression. When the connecting member (104) is turned, according to FIG. 8a, the emptying member (107) can be removed, the channels (114,114′) are then no longer connected with the collection (112) and reaction (103) compartments, whereby the fluidtightness member (115) maintains the depression in the cavity (113).

According to FIG. 8c, the connecting member (104) comprises a channel (174) arranged so as to be able to connect, depending on the position of the connecting member (104), the cavity (113) with an exhaust channel (184) in connection with the collection compartment (112), preferably arranged along the wall of tube (102). It is thus possible for the air contained in the cavity (113) to be able to escape when towards the collection compartment (112) in order to ensure complete filling of the reaction compartment (103) during the transfer of liquid coming from the collection compartment (112) via the connecting channel (114). This air exhaust proves necessary when the sectional area of the channel (114) or (114′) is generally less than 15 mm2 because the surface tension of the liquid and/or the viscosity thereof prevents air from circulating towards the collection compartment (112) to leave room for the liquid in the cavity (113). The sectional area of the channels (174, 184) is preferably less than 2 mm2 so as to prevent the liquid from infiltrating therein too quickly before repositioning the connecting member (104) so as to close the connection between the channel (174) and the cavity (113). A hydrophobic filter (194) is preferably positioned at the end of the exhaust channel (184) so as to prevent the fluid contained in the collection compartment (112) from infiltrating into the exhaust channel (184).

An electromagnetic member (195) is optionally placed near or around the amplification device (1) so as to be able to move a magnetic member (196) placed in the collection compartment (112). Upon activating the electromagnetic member (195), the magnetic member (196) is actuated so as to move and thus produce a mixing movement in the collection compartment (112) by varying the magnetic field produced by the electromagnetic member (195). It is also possible to place another electromagnetic member (not shown) close to, or around, the reaction compartment (103), and another magnetic member (not shown) in the cavity (113) so as to stir/mix the fluid in the cavity (113) as previously described.

An operable vibrating/stirring member (197) is preferably placed in direct or indirect contact with the amplification device (1) so as to generate a vibration/stir in the fluid contained in the, or in one of the, collection (112) and reaction (103) compartments. This vibration makes it possible to stir all or part of the fluid in order to homogenize the mixture and thus to ensure better dispersion of the components. This vibration/stir also makes it possible to release the air contained in the cavity (113) while transferring the fluid from the collection compartment (112). The stir/vibration may be of short duration in the form of a pulse/jolt.

According to FIGS. 8d and 8e, the amplification device (201) comprises a cap (220), preferably forming part of the amplification device (201) and foldable, so as to be able to open and close the amplification device (210). The cap (220) is designed in such a manner as to form a cavity (227) intended to receive a push button (225), preferably partially hollowed out, and a solution (250). The cap (220) is also designed so as to form a cavity (267) intended to receive an ingredient (260), preferably lyophilized as a powder or bead.

A closure member (249) is preferably heat sealed to the cap so that the solution (250) and the ingredient (260) can be kept in the cap prior to using the amplification device (201). The closing member (249) is preferably designed with a fluidtight material, resistant and able to be detached from the cap so as to form a capping, such as for example aluminum film. The cap (220) comprises a deformable part (221) in contact with the push button (225) itself being in contact with the closing member (249). When the cap (220) is in closed position on the amplifying device (201) and the deformable part (221) is pressed, the push button is then constrained in such a manner as to move against the closing member (249) and partially detaches it from the cap (225) thereby releasing the solution (250) and the ingredient (260) into the collection compartment (212) formed by the tube (202).

The sample (270) can be introduced into the amplification device (201) before or after releasing the solution (250) and/or the ingredient (260) into the collection compartment (212).

The amplification device (201) preferably comprises a widened zone (242) above the collection compartment (212) so as to form a funnel facilitating the introduction of the sample (270) and also making it possible to adapt the size of the cap (220) to form the cavities (227, 267) having a sufficient volume.

The amplification device (201) comprises in the same manner as previously described, a connecting member (204) whose connecting channel (214) makes it possible to connect the collection compartment (212) with the reaction compartment (203).

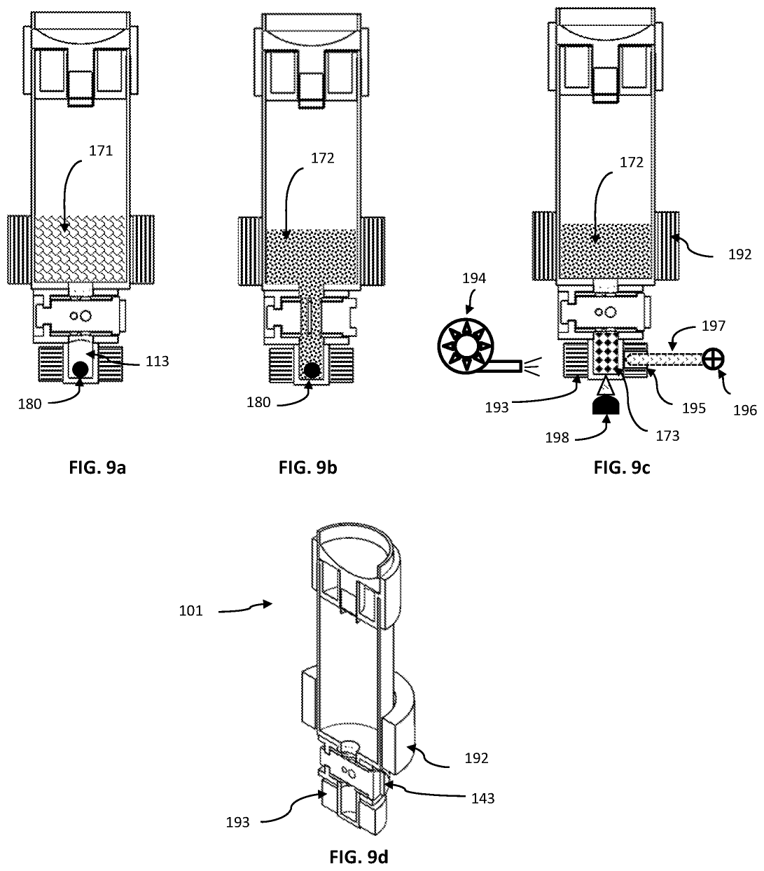

According to FIGS. 9a to 9d, the amplification device (101) is placed in an apparatus (not shown) comprising a first thermoregulated member (192), preferably of annular shape, arranged so as to modify the temperature of the collection compartment (112) and a second thermoregulated member (193), preferably of annular shape, arranged so as to modify the temperature of the cavity (113) of the reaction compartment (103).

The mixture (171) comprising the solution (150), the sample (170) and the ingredient (160) is preferably heated to a temperature above room temperature and preferably in the case of proteinase K to a temperature of 95° C. for 5 minutes by the thermoregulated member (192) so as to deactivate proteinase K. The heating or cooling conditions may vary according to the protocol to be followed and the composition of the mixture (171).

A portion of the heated mixture (172) is then transferred, preferably after a cooling time period, from the collection compartment (112) to the cavity (113) by rotating the connecting member (104), via an external mechanism (not shown) engaged with a bearing edge (143) of the connecting member (104), so as to put channel (114), and optionally channel (114′) in contact with the two collection (112) and reaction (103) compartments which has the effect of sucking the heated mixture (172) through the initial depression in the cavity (113). The volume of the cavity (113) is preferably less than 200 ul.

It is possible not to create a depression in the cavity (113), transferring the heated mixture (172) from the collection compartment (112) to the reaction compartment (103) takes place by plain gravity when the channels (114, 114′) are in connection with the collection (112) and reaction (103) compartments. The air present in the cavity (113) can then escape through at least one of the channels (114,114′) so as to let the heated mixture (172) fill the cavity (113). The sectional areas of the channels (114, 114′) are preferably different from another so as to create an air and liquid differential flow and thus facilitate filling the cavity (113).

Once the cavity (113) has been filled, the connecting member (104) is again turned so as to again isolate cavity (113) from the collection compartment (112). The heated mixture (172) is then combined with the reagent (180) and then heated again via the thermoregulated member (193), so as to carry out the amplification. In the case of an isothermal amplification, the temperature is kept constant whereas, for PCR-type amplification, thermal variation cycles are carried out in combination with the thermoregulated member (193) and a cooling fan (194).

During amplification, a light source (196) preferably in the form of a luminescent laser diode illuminates the cavity (113) with a beam (197) via an opening (195) provided in the thermoregulated member (193). A photodiode (198), preferably placed at 90° relative to the beam (197) makes it possible to measure the fluorescence in the cavity (113) and the possible presence of the DNA or RNA sought is thus detected. The system is perfectly adapted to also detect luminescent reactions depending on the type of reagent (180) used.

During the amplification, the cavity (113) preferably remains closed so as to avoid any contamination towards the outside.

Once the amplification is complete, the control electronics associated with software records all the parameters necessary for generating an analysis report and for diagnosis. The collected data is then stored and transmitted by any auxiliary means to any other data processing and storage system. The control electronics control all the elements previously described in such a manner as to ensure proper system operation, manage alerts, establish communications with external devices by wired connection (e.g. USB, Ethernet, etc.) or wireless (Bluetooth, RFID, WiFi, etc.), receive or issue commands, transmit or receive data, update software elements, emit sounds, activate indicator lights or any other action necessary to implement the system and its network interconnection.

The system preferably comprises a bar code or RFID chip reader so as to be able to automatically adapt the amplification protocol specific to each amplification device (1, 101) used. The barcode or RFID chip reader can also be used to read an identification number of the sample, associated with a patient or its origin, and to ensure transfer of the processing and amplification result data with an identification key.

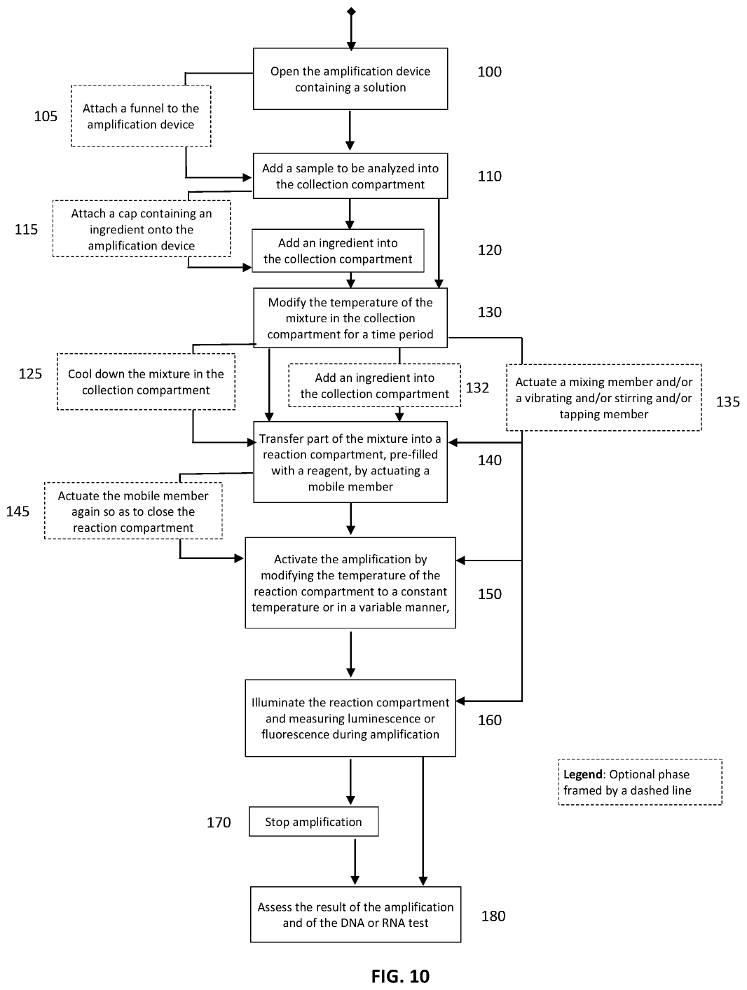

According to FIG. 10, the method for implementing the device according to the invention comprises the following successive steps:
a step 100 consisting in opening the device containing a solution,
a step 110 consisting in adding a sample to be analyzed into the collection compartment,
a step 120 consisting in adding an ingredient into the collection compartment,
a step 130 consisting in modifying the temperature of the mixture in the collection compartment for a time period,
a step 140 consisting in transferring part of the mixture into a reaction compartment, pre-filled with a reagent, by actuating a mobile member,
a step 150 consisting in activating the amplification by modifying the temperature of the reaction compartment to a constant temperature or in a variable manner,
a step 160 consisting in illuminating the reaction compartment and measuring luminescence or fluorescence during amplification,
a step 170 consisting in stopping the amplification,
a step 180 consisting in assessing the result of the amplification and of the DNA or RNA test
   Steps 130 to 180, are carried out by an apparatus into which the amplification device is introduced.

Several intermediate and optional steps (framed in a dashed line in FIG. 10) make it possible to improve, simplify and optimize the amplification process in order to render the device faster, easier to use, in particular:
a step 105 consisting in attaching a funnel to the amplification device,
a step 115 consisting in attaching a cap containing an ingredient onto the amplification device,
a step 125 consisting in cooling down the mixture in the collection compartment,
a step 132 consisting in adding another ingredient after step 130
a step 135 consisting in actuating a mixing member and/or a vibrating and/or stirring and/or tapping member,
a step 145 consisting in actuating the mobile member again so as to close the reaction compartment

Implementing a LAMP, PCR, RT-LAMP or RT-PCT type amplification by this method thus makes it possible to quickly carry out a diagnostic test by a patient directly without qualified personnel intervening, and this from anywhere thanks to a portable device that may be battery operated.

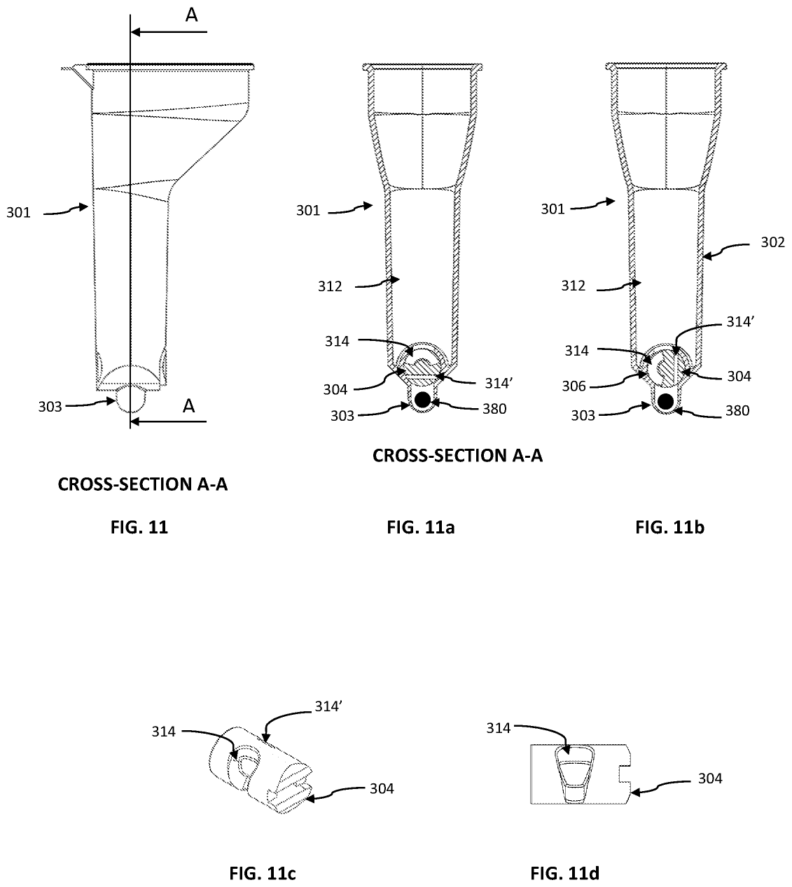

According to FIGS. 11 to 11d, the connecting member (304) placed in the amplification device (301) comprises a channel (314) located on the outer part of the connecting member (304), preferably in the form of a recess or indentation. The connecting member (304) comprises a second channel (314′) passing through or possibly in the form of a recess or indentation similar to channel (314). According to FIG. 11a, when the connecting member (304) is in closed position, the fluid contained in the collection compartment (312) comes into contact with channel (314) while channel (314′) remains closed thanks to the fluidtightness achieved by tightening the connecting member (304) in the cavity (306).

According to FIG. 11b, when the connecting member is turned, preferably by 90°, into the open position, by an external member (not shown), the fluid contained in channel (314) is then directed towards the reaction compartment (303) so as to fill it and thus transfer the mixture to be amplified to the reagent (380). The length of the channel (314) is set to allow a direct connection between the collection compartment (312) and the reaction compartment (303). The air contained in the reaction compartment (303) is expelled towards the collection compartment (312) via the channel (314′), the sectional area of which is as small as possible, which is connected to the collection compartment (312) and the reaction compartment (303). It is thus possible to purge the air from the reaction compartment (303) in a simple and effective manner while avoiding a possible rise of the mixture to be transferred during the air evacuation via the channel (314′). This proves particularly important if the device is constrained by vibrations/stirs as previously described.

According to FIG. 11d, channel (314) possibly has an asymmetrical shape so that the volume of fluid flowing into the reaction compartment (303) is at a maximum and creates a depression on the upper part of the channel (314) in connection with the collection compartment (312). The channel cross-section can thus be adapted according to the the desired flow and time period.

The amplification takes place after having repositioned the connecting member (304) into the closed position.

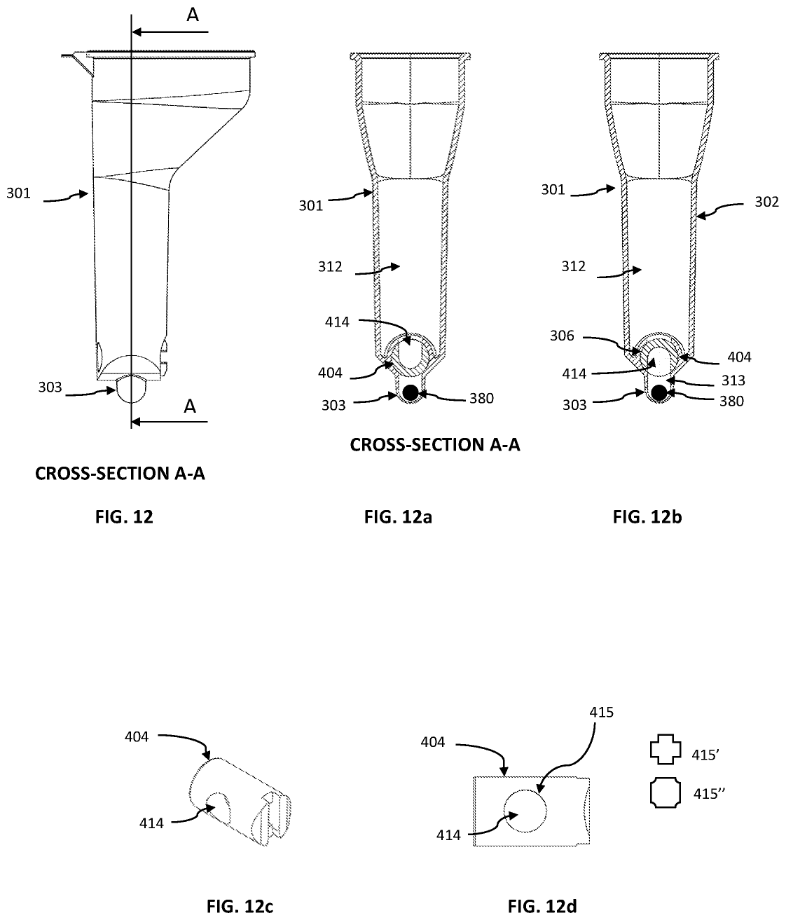

According to FIGS. 12 to 12d, the connecting member (404) placed in the amplification device (301) comprises a cavity (414) located on the outer part of the connecting member (404), preferably in the form a recess, indentation or non-through hole. According to FIG. 12a, when the connecting member (404) is in closed position, the fluid contained in the collection compartment (312) comes into contact with the cavity (414) and the rest of the fluid does not reach the reaction compartment (303) thanks to the fluidtightness achieved by tightening of connecting member (404) in the cavity (306).

According to FIG. 12b, when the connecting member is turned, preferably by 180°, into the open position, by an external member (not shown), the fluid contained in cavity (414) is then directed towards the reaction compartment (303) so as to fill it and thus transfer the mixture to be amplified to the reagent (380). The volume of the cavity (414) can be different from the volume of the cavity (313) of the reaction compartment (303) so as to be able to adjust the volume of the mixture to be transferred from the collection compartment (312) into the reaction compartment (303). The volume of the reaction chamber formed by cavity (414) and cavity (313) possibly contains the air present in the reaction compartment (303) prior to fluid transfer from the collection compartment (312). It is perfectly possible to carry out DNA/RNA amplification with the presence of air, without purging it.

According to FIG. 12d, the cross-section (415) of the cavity (414) is preferably non-circular like cross-sections (415′, 415″), so as to facilitate the mixture transfer from the collection compartment (312) to the reaction compartment (303) by creating a non-homogeneous adherence of the fluid in the cavity (414). These non-circular cross-sections (415′, 415″) also facilitate filling the cavity (414) by allowing air to escape via several locations including in particular along the edges in the corners of the non-circular cross-sections (415′, 415″) where the fluid adheres more difficultly because of its surface tension.

It is preferable to vibrate, stir or tap onto the amplification device (301), directly or indirectly, when the connecting member (404) is in the closed position, so that the mixture to be transferred properly fills the cavity (414). It is also preferable to vibrate, stir or tap onto the amplification device (301), directly or indirectly, when the connecting member (404) is in open position, so that the mixture to be transferred descends properly from cavity (414) to cavity (313) and reagent (380).

This configuration brings the advantages allowing to carry out amplification without having to reposition the connecting member (304) into the closed position once the transfer of the mixture has been carried out, and that there is no risk that a part of the reagent (380) would rise into the collection compartment (312)

### Variants of the invention

According to several implementation variants of the invention, the following changes and/or additions may be made to the various embodiments previously described:
the solution (50,150,250) can be added into the collection compartment (12,112, 212,312) after the sample (70,170,270) has been introduced;
adding the ingredient (60,160,260) can be performed before introducing the sample (70,170, 270);
the reaction compartment (3,103, 203,303) is preferably made of transparent or translucent material;
the parts of the amplification device (1,101,201,301) are preferably made of plastics of the following types: PP, PE, PET, PETC, ABS, PC, HPDE, Copolyster, NBR, EPDM, VMQ, LSR or any other type and manufactured by injection.
the thickness of the walls of the collection (12,112,212,312) and reaction (3,103,203,303) compartments is preferably less than 2 mm;
the amplification device (1,101,201,301) is preferably disposable for single use.
the thermoregulated members (92,93,192,193) are preferably arranged coaxially in the apparatus receiving the device (1,101,201,301);
it is possible to create other additional compartments and to add other connecting members between these compartments.
it is possible to arrange the connecting member (4,104,204,304) according to other execution modes, for example in such a manner as to make it slidably mobile or mobile per pressure so as to connect the collection (12,112,212) and reaction (3,103,203) compartments;
the connecting member (4,104,204,304,404) can be designed according to any flap valve, membrane, check-valve or other technique that is manually, electrically or mechanically operable;
fluidtightness of the connecting member (4,104,204,304,404) can be achieved without seal by simple fitting of the parts;
the collection compartment (12, 112, 212,312) can be provided other than by a tube including in particular a spherical cover or any other shape making it possible to create a volume intended to receive all or part of the sample (70,170,270) or all or part of the solution (50,150,250);
a removable member (not shown) can be arranged in connection with the exhaust channel (184), preferably in the form of a piston, so as to be able to be actuated from the outside in order to modify the pressure in the exhaust channel (184) and thus suck in or expel all or part of the fluid into the reaction compartment (3, 103,203,303).
it is possible to add other light sources and photodiodes having different emission frequencies so as to be able to detect several elements in the reaction compartment (3,103,203) such as controls for the presence of specific DNA and/or RNA to ensure proper operation of the device and test;
it is preferably necessary to use optical filters between the light source(s) and the reaction compartment (3,103,203,303) allowing precise selection of the illumination frequencies of the reaction compartment (3,103,203,303);
it is preferably necessary to use optical filters between the photodiode(s) and the reaction compartment (3,103,203,303) allowing precise selection of the radiation frequencies coming from the reaction compartment (3,103,203,303);
the optical filters are preferably designed so as to filter a frequency comprised between 300 and 800 nm with a bandwidth preferably less than 50 nm.
it is possible to adapt the device for other amplification, diagnostic and analysis techniques such as, in particular, but not limited to, NASBA-Nucleic Acid Sequence Based Amplification, RCA-Rolling Cycle Amplification, HDA-Helicase-dependent Amplification or in combination with the CRISPR technique-Clustered Regularly Interspaced Short Palindromic Repeats.
it is possible to integrate an accelerometer in an apparatus receiving the amplification device (1,101,201,301) so as to detect the position of use of the apparatus, and also to measure the vibrations/stirs while the device is in use.
the sectional area of the channel (14, 114, 214, 314) is preferably between 2 and 20 mm2
the sectional area of the connecting member (1, 104, 204, 304, 404) is preferably between 10 and 50 mm2
the tube (2,102,202,302) can have a non-cylindrical section, for example oval, square, rectangular or other.
the volume of the solution (50,150,250) is preferably less than 3 ml and ideally from 0.5 to 1.5 ml.
it is possible to duplicate the collection (112, 212,312) and reaction (103,203,303) compartments so as to be able to carry out several separate amplifications with the same amplification device (101,201,301). The connecting member (104,204,304,404) can be duplicated or adapted so as to be able to independently or simultaneously transfer the mixture from the collection compartment(s) (112, 212,312) to the reaction compartment(s) (103,203,303). This proves to be particularly useful if it is desired to increase the number of channels for reading the luminescent signal(s) because it is possible to process one or more sample(s) according to different formulations of the reagent (180,280,380), whereby the sample(s) is (are) intended for testing, for example, influenza, Ebola and Covid-19 at the same time.

Although the invention is described according to several embodiments, other variants which are not presented do exist. The scope of the invention is therefore not limited to the embodiments described above.

1. DNA or RNA amplification device (1,101,201,301), comprising at least one collection compartment (12,112,212,312) connected to at least one reaction compartment (3,103,203,303) by at least one connecting member (4,104,204,304,404) comprising one month a channel (14,114,214,34) or cavity (414), for duplicating in great number a DNA or RNA sequence of a sample (70,170,270) introduced into the collection compartment (12,112,212,312) with at least one solution (50,150,250) so as to form a mixture characterized in that part of the mixture is transferred from the collection compartment (12,112,212,312) to the reaction compartment (3,103,203,303) when the connecting member (4,104,204,304,404) is actuated from its closed position to its open position in an external manner.

2. Amplification device according to claim 1, the parts of which are made of injected plastic.

3. Amplification device according to claim 1, intended for single use and is disposable.

4. Amplification device according to claim 1, wherein the connecting member (4,104, 204,304) is movable;

5. Amplification device according to claim 1, wherein the reaction compartment (3,103, 203,303) is made of transparent or translucent material;

6. Amplification device according to claim 1, wherein the connecting member (104) comprises a channel (174) in connection with the reaction compartment (3, 103) and an exhaust channel (184) preferably connected to the collection compartment (112);

7. Amplification device according to claim 1, wherein the reaction compartment (3) moves relative to the collection compartment (12);

8. Amplification device according to claim 1, wherein the connecting member (4,104, 204,304) is made of elastomer or is in contact with a fluidtightness member (115) made of elastomer;

9. Amplification device according to claim 1, wherein the reaction compartment (3, 103,203,303) forms a cavity (13,113,213,313) the internal pressure of which can be modified;

10. Amplification device according to claim 1, wherein the volume of the collection compartment (12, 112,212,312) is less than 30 ml;

11. Amplification device according to claim 1, wherein the volume of the reaction compartment (3,103,203,303) is less than 200 ul;

12. Amplification device according to claim 1, wherein the reaction compartment (3,103,203,303) contains a reagent (80,180,280,380);

13. Amplification device according to claim 1, wherein the temperature of the collection compartment (12,112,212) can be modified by a thermoregulated member (92, 192) preferably surrounding it;

14. Amplification device according to claim 1, wherein the temperature of the reaction compartment (3,103,203) can be modified by a thermoregulated member (93, 193) preferably surrounding it;

15. Amplification device according to claims 13 and 14, wherein the thermoregulated members (92, 93, 192, 193) are co-axial with each other;

16. Amplification device according to claim 1, wherein the thickness of the wall of the reaction compartment (3,103,203,303) is less than 2 mm;

17. Amplification device according to claim 1, wherein the fluid that it contains can be mixed by a magnetic member (196) contained in the collection compartment (12, 112,212,312);

18. Amplification device according to claim 1, wherein the fluid that it contains may be subjected to vibration/stir originating from a vibrating/stirring member (197) by direct or indirect contact;

19. Amplification device according to claim 1, wherein the reaction compartment (3, 103,203,303) comprises a reagent (80,180,280,380) preferably lyophilized as a powder or bead;

20. Amplification device according to claim 1, comprising a cap (20, 120, 220) containing a solution (50, 150, 250);

21. Amplification device according to claim 1, comprising a cap (20, 120, 220) containing an ingredient (60, 160, 260);

22. Amplification device according to claim 1, comprising a push button (25, 125, 225) in contact with a cap (20, 120, 220);

23. Amplification device according to claim 1, comprising a closing member (249) in contact with a cap (20, 120, 220);

24. Amplification device according to claim 1, comprising a cap (20, 120, 220) having a deformable part (221);

25. DNA or RNA amplification device intended for tests of the PCR, qPCR, RT-PCR, RT-qPCR, LAMP, RT-LAMP, NASBA, RCA or HDA type comprising the amplification device according to claim 1;

26. Method for implementing the amplification device according to any one of claims 1 to 25, comprising in particular the following steps:
i. opening the device containing a solution,
ii. adding a sample to be analyzed into the collection compartment,
iii. adding an ingredient into the collection compartment,
iv. modifying the temperature of the mixture in the collection compartment for a time period,
v. transferring part of the mixture into a reaction compartment, pre-filled with a reagent, by actuating a mobile member,
vi. activating the amplification by modifying the temperature of the reaction compartment to a constant temperature or in a variable manner,
vii. illuminating the reaction compartment and measuring luminescence or fluorescence during amplification,
viii. stopping the amplification,
ix. assessing the result of the amplification and of the DNA or RNA test.
